(19) United States
(12) Patent Application Publication
(10) Pub. No.: US 2005/0139491 A1
(43) Pub. Date: Jun. 30, 2005

(54) Oxygen concentration detecting apparatus and method

(75) Inventor: Shigeo Ohkuma, Isesaki-shi (JP)

Correspondence Address: FOLEY AND LARDNER;SUITE 500, 3000 K STREET NW, WASHINGTON, DC, 20007, US

(73) Assignee: HITACHI, LTD.

(21) Appl. No.: 11/019,224

(22) Filed: Dec. 23, 2004

(30) Foreign Application Priority Data
Dec. 26, 2003 (JP) 2003-435777
Nov. 16, 2004 (JP) 2004-331453

(51) Int. Cl. G01N 27/26

(52) U.S. Cl. 205/782; 204/424

(57) ABSTRACT

In an oxygen concentration detecting apparatus for measuring an electromotive force produced in correspondence to a difference between the oxygen partial pressure of a standard electrode and the oxygen partial pressure of a measuring electrode by applying a voltage between the standard electrode and the measuring electrode, when an oxygen excessive state or a high temperature state of a detecting element continues for at least a predetermined time, the voltage applied between the standard electrode and the measuring electrode or a heater voltage is reduced.

### BACKGROUND OF THE INVENTION

1. Field of the Invention

The present invention relates to an oxygen concentration detecting apparatus and method used to detect an oxygen concentration in, for example, exhaust gas in an internal combustion engine.

2. Description of the Related Art

Japanese Unexamined Patent Publication No. 59-148857 discloses an oxygen concentration detecting apparatus for detecting an oxygen concentration in to-be-measured gas. The oxygen concentration detecting apparatus is arranged such that a substrate, a standard electrode, an oxygen ion transmissive solid electrolyte, and a measuring electrode are laminated, the measuring electrode is divided into an energizing electrode and a reference electrode, an oxygen partial pressure in the standard electrode is controlled by applying current between the standard electrode and the energizing electrode, and the oxygen concentration in the to-be-measured gas is detected based on an electromotive force produced between the standard electrode and the reference electrode.

Incidentally, since internal combustion engines with a small engine displacement mounted on motor cycles uses an exhaust pipe having a small diameter, an oxygen concentration detecting element mounted on the exhaust pipe must be reduced in size.

However, the thickness of laminated members must be reduced to reduce the size of the detecting element, thereby the mechanical strength of the detecting element is reduced.

In contrast, in the above oxygen concentration detecting apparatus, the pressure in the detecting element may be increased by the oxygen excessively accumulated to the standard electrode. Accordingly, when the strength of the detecting element is reduced, there is a possibility that detecting element is broken by an increase in the internal pressure thereof.

### SUMMARY OF THE INVENTION

Accordingly, an object of the present invention is to prevent the breakage of a detecting element due to oxygen excessively accumulated to a standard electrode.

To achieve the above object, in the present invention, the amount of oxygen accumulated to a standard electrode is estimated, and when it is estimated that the accumulated amount of oxygen reaches a threshold value, the amount of manipulation of a detecting element is changed in a direction where the amount of oxygen flowing to the standard electrode is suppressed.

The other objects and features of this invention will become understood from the following description with reference to the accompanying drawing.

### BRIEF EXPLANATION OF THE DRAWINGS

FIG. 1 is a block diagram showing an arrangement of an oxygen concentration detecting apparatus according to an embodiment;

FIG. 2 is a sectional view showing an arrangement of the oxygen concentration detecting element according to the embodiment; and

FIG. 3 is a flowchart showing a sequence for setting a bias voltage and a heater voltage according to the embodiment.

### DESCRIPTION OF THE PREFERRED EMBODIMENTS

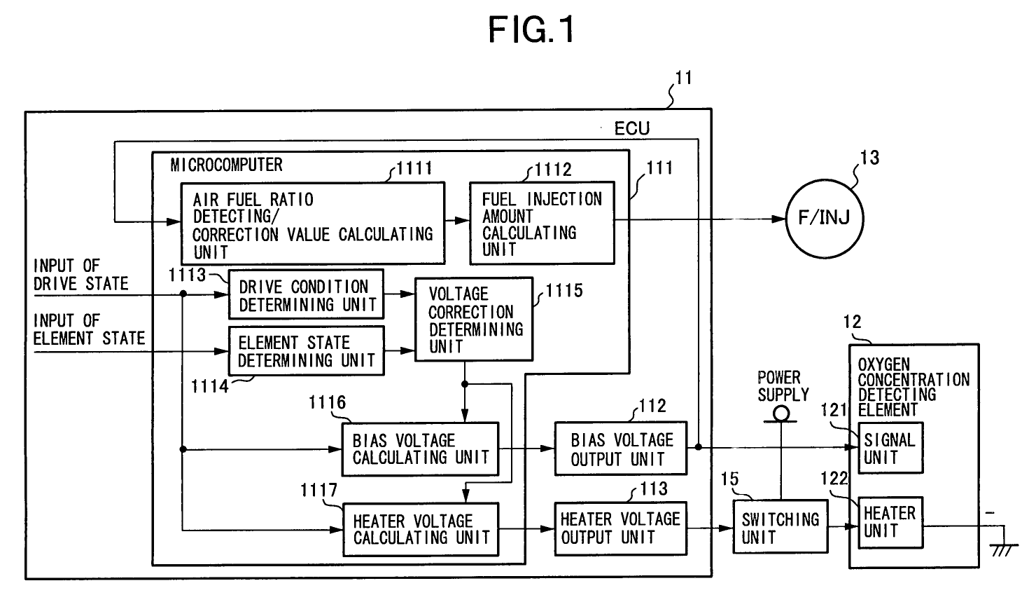

FIG. 1 is a block diagram showing an air fuel ratio control system of an internal combustion engine including an oxygen concentration detecting apparatus according to an embodiment of the present invention.

The oxygen concentration detecting apparatus according to the embodiment detects the oxygen concentration in an exhaust gas which has a close relation to the air fuel ratio in the internal combustion engine by mounting a detecting element 12 on an exhaust pipe of the internal combustion engine.

In the air fuel ratio control system, the amount of fuel injected into the internal combustion engine is feed-back controlled based on the air fuel ratio determined from the oxygen concentration in the exhaust gas.

The internal combustion engine is mounted on, for example, a motor cycle.

In FIG. 1, an engine control unit (ECU) 11, which controls a fuel injection amount as well as controls the detecting element 12, includes a microcomputer 111.

The detecting element 12 is controlled by the microcomputer 111, a bias voltage output unit 112, and a heater voltage output unit 113.

The microcomputer 111 includes an air fuel ratio detecting/correction value calculating unit 1111, a fuel injection amount calculating unit 1112, a drive condition determining unit 1113, an element state determining unit 1114, a voltage correction determining unit 1115, a bias voltage calculating unit 1116, and a heater voltage calculating unit 1117.

The air fuel ratio detecting/correction value calculating unit 1111 detects the air fuel ratio in response to the bias voltage output from the bias voltage output unit 112 and to the signal of the oxygen concentration detected by the detecting element 12. Further, the air fuel ratio detection/correction value calculation unit 1111 calculates the correction value of the fuel injection amount based on a detection result of the air fuel ratio and outputs the correction value to the fuel injection amount calculating unit 1112.

The fuel injection amount calculating unit 1112 corrects the fuel injection amount based on the correction value supplied from the air fuel ratio detecting/correction value calculating unit 1111 and controls a fuel injection device 13 based on the corrected fuel injection amount.

The drive condition determining unit 1113 is supplied with, for example, an engine rotational speed of the internal combustion engine, a fuel injection amount, an intake pipe pressure, a vehicle velocity, an air fuel ratio, an exhaust gas temperature, and the like as the drive state of a vehicle, and determines the drive state of a vehicle based on the information supplied thereto.

Further, the element state determining unit 1114 is supplied with actually measured values of, for example, an element temperature, an element impedance, an element internal stress, and the like as a state of detecting element 12 and determines the state of detecting element 12 based on the information supplied thereto.

Estimated values of the element temperature, the element impedance and the element internal stress may be used in place of the actually measured values thereof. The element temperature can be estimated based on an exhaust gas temperature, and the element impedance can be estimated based on the impedance of a heater for heating the detecting element.

Results of determination of the drive condition determining unit 1113 and the element state determining unit 1114 are output to the voltage correction determining unit 1115.

The voltage correction determining unit 1115 estimates the amount of oxygen accumulated to the standard electrode of the detecting element 12 from the drive state and the element state and determines whether a bias voltage and a heater voltage that applied to the detecting element 12 are to be changed. The voltage correction determining unit 1115 outputs results of determination as to whether the voltages are to be changed to the bias voltage calculating unit 1116 and the heater voltage calculating unit 1117.

When the state that the temperature of the detecting element 12, which is estimated from the engine rotational speed, the fuel injection amount, the intake pipe pressure, the vehicle velocity, the air fuel ratio, the exhaust gas temperature, and the like, exceeds, for example, 650° C. or the state that the temperature of the detecting element 12 detected by a sensor exceeds, for example, 650° C. continues for a predetermined time, the voltage correction determining unit 1115 determines that the amount of oxygen accumulated to the standard electrode of the detecting element 12 reaches a threshold value and instructs to reduce the bias voltage and the heater voltage.

Further, when the state that the air fuel ratio is leaner than, for example, a theoretical air fuel ratio continues for a predetermined time, the voltage correction determining unit 1115 determines that the amount of oxygen accumulated to the standard electrode of the detecting element 12 reaches the threshold value and instructs to reduce the bias voltage and the heater voltage.

On receiving the instruction for reducing the bias voltage, the bias voltage calculating unit 1116 reduces the bias voltage to about 1.0 V when it is an ordinary voltage of about 1.2 V.

Further, on receiving the instruction for reducing the heater voltage, the heater voltage calculating unit 1117 reduces the heater voltage to about 10 V when it is an ordinary voltage of about 13 V.

The bias voltage output unit 112 applies the bias voltage calculated by the bias voltage calculating unit 1116 to the detecting element 12.

The heater voltage output unit 113 controls the turning on/off of a switching unit 15 so that a target voltage calculated by the heater voltage calculating unit 1117 is applied to a heater unit 122.

The switching unit 15 has a function for turning off a heater drive current upstream of the heater unit 122.

When the healer drive current supplied to the heater unit 122 is shut off by a switching means disposed downstream of the heater unit 122, that is, interposed between the heater unit 122 and a ground potential, a potential is produced to the heater unit 122 before the heater drive current is shut off. When the heater drive current is shut off, a large amount of oxygen flows from the heater unit 122 to the standard electrode of the detecting element 12. As a result, there is a possibility that the detecting element 12 is broken by an increase in the internal pressure of the detecting element 12.

In contrast, the switching unit 15 disposed upstream of the heater unit 122 can prevent the oxygen from flowing to the standard electrode when the drive current to the heater unit 122 is shut off, thereby the breakage of the detecting element 12 can be prevented.

The detecting element 12 includes a signal unit 121 and the heater unit 122, the signal unit 121 detecting the oxygen concentration in a to-be-measured gas (exhaust gas) based on the bias voltage applied from the bias voltage output unit 112, and the heater unit 122 heating the detecting element 12 based on the heater voltage applied from the heater voltage output unit 113.

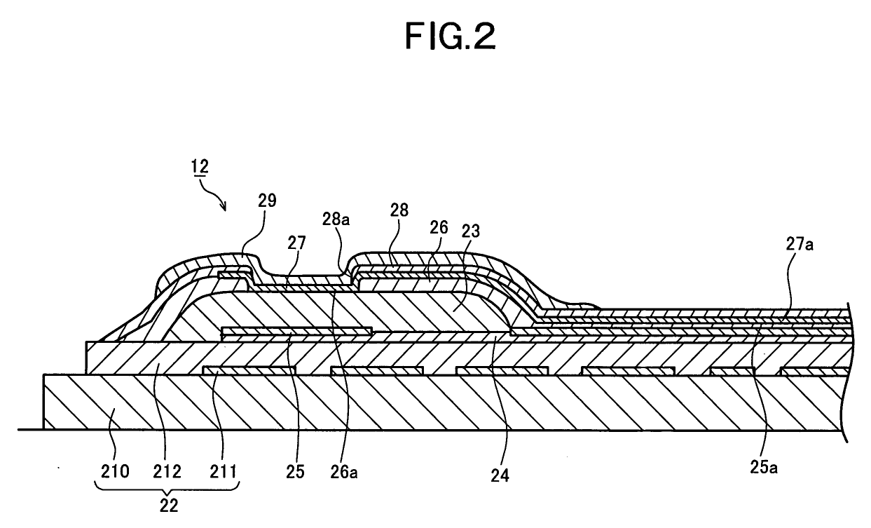

FIG. 2 is a sectional view showing an arrangement of the detecting element 12.

In FIG. 2, the detecting element 12 includes a base member 22, an oxygen ion transmissive solid electrolyte layer 23, a porous layer 24, an inside electrode 25 (standard electrode), an inside dense layer 26, an outside electrode 27 (measuring electrode), an outside dense layer 28, and a protection layer 29. The solid electrolyte layer 23 is formed on the outside surface side of the base member 22. The porous layer 24 is interposed between the inside surface of the solid electrolyte layer 23 and the outside surface of the base member 22 and composed of a porous material. The inside electrode 25 (standard electrode) is formed on the inside surface of the solid electrolyte layer 23. The inside dense layer 26 is formed on the outside surface of the solid electrolyte layer 23 and has an electrode window 26a. The outside electrode 27 (measuring electrode) is formed on the outside surface of the inside dense layer 26 and on the outside surface of the solid electrolyte layer 23 exposed by the electrode window 26a. The outside dense layer 28 is formed on the outside surface of the outside electrode 27 and has an oxygen introducing window 28a at the same position as the electrode window 26a. The protection layer 29 is formed on the outside surface of the outside dense layer 28 and the outside surface of the outside electrode 27 exposed by the oxygen introducing window 28a.

The outside dense layer 28 and the protection layer 29 are exposed to the to-be-measured gas (exhaust gas in the exhaust pipe) on the outsides thereof.

The base member 22 is composed of a rod 210, a heater pattern 211, which is formed around the outer periphery of the rod 210, and a heater covering layer 212 as an insulation material formed around the outer periphery of the rod 210 so as to cover the heater pattern 211.

The rod 210 is formed of a ceramic material, for example, alumina, and the like.

The heater pattern 211 is formed of a heat generating conductive material such as tungsten, platinum, and the like, and the temperature of the solid electrolyte layer 23 and the like are increased to an activation temperature by the heat generated by the heater pattern 211.

The solid electrolyte layer 23 is formed of, for example, a paste-like material composed of, for example, zirconia powder mixed with yttria powder at a predetermined mixing ratio by weight.

The solid electrolyte layer 23 can generate an electromotive force between the inside electrode 25 (standard electrode) and the outside electrode 27 (measuring electrode) according to a difference between oxygen densities, and transport oxygen ions.

The porous layer 24 is formed of a ceramic material such as alumina, and the like and constitutes a path for escaping the oxygen transported to the inside electrode 25 through the solid electrolyte layer 23.

The inside electrode 25 and the outside electrode 27 are formed of platinum and the like which have conductivity as well as is a material through which the oxygen passes.

Lead wires 25a and 27a are disposed to the inside electrodes 25 and outside electrodes 27 integrally therewith, respectively so that a potential difference between the inside electrode 25 and the outside electrode 27 can be detected using the lead wires 25a and 27a.

The inside dense layer 26 is formed of a material, for example, a ceramic material such as alumina and the like through which the oxygen in the to-be-measured gas cannot pass to the inside surface thereof.

The inside dense layer 26 covers the entire outside surface of the solid electrolyte layer 23, and the electrode window 26a is formed by cutting off a part of the inside dense layer 26.

The electrode window 26a has a dimension smaller than that of the inside electrode 25 in both an axial direction and a circumferential direction.

The outside dense layer 28 is formed of a material, for example, the ceramic material such as alumina and the like through which the to-be-measured gas cannot pass to the inside surface thereof likewise the inside dense layer 26, and the oxygen introducing window 28a is formed by cutting a part of the outside dense layer 28 at the same position as the electrode window 26a.

The protection layer 29 covers the outside electrode 27, which is exposed to the outside through the oxygen introducing window 28a of the outside dense layer 28, from the outside and is formed of a porous structural member composed of a material, for example, a mixture of alumina and magnesium oxide through which the harmful gases, dusts, and the like in the to-be-measured gas cannot pass to the inside surface side but the oxygen in the to-be-measured gas can pass to the inside surface side.

The detecting element 12 arranged as described above controls the oxygen partial pressure in the inside electrode 25 (standard electrode) by causing the oxygen ions in the solid electrolyte layer 23 to migrate by connecting an external power supply between the inside electrode 25 and the outside electrode 27. Further, the detection device 12 measures an electromotive force, which corresponds to a difference between the oxygen partial pressure in the inside electrode 25 (standard electrode) and the oxygen partial pressure in the outside electrode 27 (measuring electrode) exposed to the to-be-measured gas as a value corresponding to the oxygen concentration in the to-be-measured gas.

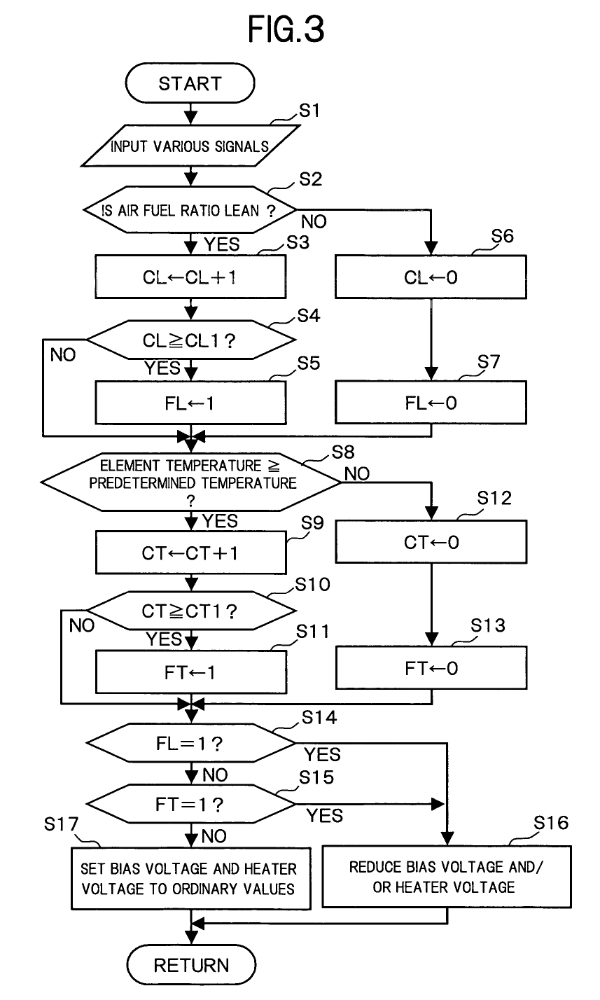

Next, a sequence for setting the bias voltage and the heater voltage which is applied to the detecting element 12 will be explained with reference to a flowchart shown in FIG. 3.

The various drive conditions such as an engine rotational speed, an engine load, an air fuel ratio, and the like are input at step S1, and it is determined at step S2 whether the present air fuel ratio in the internal combustion engine is leaner than that of the theoretical air fuel ratio.

The determination of lean is executed based on the air fuel ratio detected by the detecting element 12 or by a target air fuel ratio at the time.

When the air fuel ratio is lean, the process goes to step S3 at which a lean duration time is measured by incrementing a lean counter CL by 1.

At step S4, whether the lean duration time reaches a predetermined time (for example, 10 seconds) is determined by comparing the value of the lean counter CL with a predetermined value CL1.

When the value of the lean counter CL is equal to or more than the predetermined value CL1, the process goes to step S5, at which a voltage change flag FL is set to 1.

In contrast, when the value of the lean counter CL is less than the predetermined value CL1, the process go to step S8 by bypassing step S5, thereby the voltage change flag FL up to the last time is maintained.

When it is determined at step S2 that the air fuel ratio is not lean, the process goes to step S6 at which the lean counter CL is reset to zero, and further the voltage change flag FL is reset to zero at next step S7.

When the air fuel ratio is lean, oxygen continuously flows to the inside electrode 25 as the standard electrode and is excessively accumulated to the inside electrode 25, thereby the internal pressure of the inside electrode 25 increases.

Thus, whether the amount of oxygen accumulated to the inside electrode 25 reaches the threshold value is determined from the lean duration time, and when it is estimated that the amount of oxygen accumulated to the inside electrode 25 reaches the threshold value, the voltage change flag FL is set to 1.

When the air fuel ratio is leaner, the lean counter CL may be incremented by a larger value, and when a larger amount of oxygen flows to the inside electrode 25, the lean counter CL may be incremented at a higher speed.

Further, as a simplified method, when the air fuel ratio is leaner, the predetermined value CL1 may be changed to a smaller value.

At step S8, it is determined whether the temperature of the detecting element 12 is equal to or more than a predetermined temperature (for example, 650° C.).

The temperature of the detecting element 12 can be detected by the sensor, in addition to that it can be estimated by the drive conditions and an environmental temperature.

When the temperature of the detecting element 12 is equal to or more than the predetermined temperature, the process goes to step 89 at which a temperature counter CT is incremented by 1, thereby a time during which the detecting element 12 is kept at a high temperature is measured.

When the detecting element 12 has a higher temperature, the temperature counter CT may be incremented by a larger value, and when a larger amount of oxygen flows to the inside electrode 25, the temperature counter CT may be incremented at a higher speed.

Further, as a simplified method, when the detecting element 12 has a higher temperature, a predetermined value CT1 may be changed to a smaller value.

At step 10, whether the high temperature continuing time reaches a predetermined time is determined by comparing the value of the temperature counter CT with the predetermined value CT1.

When the value of the temperature counter CT is equal to or more than the predetermined value CT1, the process goes to step S11, at which a voltage change flag FT is set to 1.

In contrast, when the value of the temperature counter CT is less than the predetermined value CT1, the process go to step S14 by bypassing step S11, thereby the voltage change flag FT up to the last time is maintained.

When it is determined at step S8 that the temperature of the detecting element 12 is less than the predetermined temperature, the process goes to step S12 at which the temperature counter CT is reset to zero, and further the voltage change flag FT is reset to zero at next step S13.

When the detecting element 12 has a high temperature, the internal resistance thereof decreases and an excessive current flows between the electrodes 25 and 27, thereby a large amount of oxygen flows to the inside electrode 25 as the standard electrode. With the above operation, oxygen is excessively accumulated to the inside electrode 25 and the internal pressure thereof is increased.

Whether the amount of oxygen accumulated to the inside electrode 25 reaches the threshold value is determined from the high temperature continuing time, and when it is estimated that the amount of oxygen accumulated to the inside electrode 25 reaches the threshold value, the voltage change flag FT is set to 1.

At step S14, it is determined whether the voltage change flag FL is set to 1.

When the voltage change flag FL is set to 1, it is estimated that the lean air fuel ratio continues and the amount of oxygen accumulated to the inside electrode 25 reaches the threshold value. Accordingly, the process goes to step S16 at which processing for reducing the bias voltage and/or the heater voltage is executed to suppress the accumulation of oxygen.

In contrast, when the voltage change flag FL is set to 0, the process goes to step S15 at which whether the voltage change flag FT is set to 1 is determined.

When the voltage change flag FT is set to 1, it is estimated that the high temperature of the detecting element 12 continues and the amount of oxygen accumulated to the inside electrode 25 reaches the threshold value. Accordingly, the process goes to step S16 at which the processing for reducing the bias voltage and/or the heater voltage is executed to suppress the accumulation of oxygen.

When both the voltage change flags FL and FT are set to zero, it is not estimated that an excessive amount of oxygen is accumulated to the inside electrode 25. Accordingly, the process goes to step S17 at which the bias voltage and the heater voltage are set to ordinary values.

When the ordinary value of the bias voltage is, for example, 1.2 V, and the accumulation of oxygen is to be suppressed, the bias voltage is reduced to, for example, about 1.0 V.

When the ordinary value of the heater voltage is, for example, 13 V and the accumulation of oxygen is to be suppressed, the heater voltage is reduced to, for example, about 10 V.

The amounts of reduction of the bias voltage and the heater voltage are set within the range by which the detection of the air fuel ratio is not affected. Further, the amounts of reduction of the bias voltage and the heater voltage may be changed according to the air fuel ratio and the atmospheric temperature of the detecting element 12 at the time.

Since a decrease in the bias voltage decreases the current flowing between the electrodes 25 and 27, the amount of oxygen flowing to the inside electrode 25 can be suppressed. In contrast, a decrease in the heater voltage can increase the internal resistance of the detection device 12 by decreasing the temperature thereof, thereby the amount of oxygen flowing to the inside electrode 25 can be suppressed.

When the oxygen flowing to the inside electrode 25 can be suppressed, an increase in the internal pressure of the detection device 12 due to the accumulation of oxygen can be suppressed, thereby the detecting element 12 can be prevented from being broken by an excessive internal pressure.

The same operation/working effect can be obtained by applying the above processing for setting the bias voltage and the heater voltage also in a detecting element in which the outside electrode as the measuring electrode is divided into an energizing electrode and the reference electrode.

The entire contents of Japanese Patent Application No. 2003-435777, filed Dec. 26, 2003 and Japan Patent Application No. 2004-331453 filed Nov. 16, 2004 are incorporated herein by reference.

While only selected embodiments have been chosen to illustrate the present invention, it will be apparent to those skilled in the art from this disclosure that various changes and modifications can be made herein without departing from the scope of the invention as defined in the appended claims.

Furthermore, the foregoing description of the embodiments according to the present invention are provided for illustration only, and not for the purpose of limiting the invention as defined by the appended claims and their equivalents.

1. An oxygen concentration detecting apparatus, comprising:
a detecting element formed by laminating a standard electrode, an oxygen ion transmissive solid electrolyte, and a measuring electrode;
a measuring section for measuring an electromotive force produced in correspondence to a difference between the oxygen partial pressure of the standard electrode and the oxygen partial pressure of the measuring electrode by applying a voltage between the standard electrode and the measuring electrode;
an estimating section for estimating the amount of oxygen accumulated to the standard electrode; and
a correcting section for changing, when it is estimated that the accumulated amount of oxygen reaches a threshold value, the amount of manipulation of the detecting element in a direction where the amount of oxygen flowing to the standard electrode is suppressed.

2. An oxygen concentration detecting apparatus according to claim 1, wherein the correcting section changes a voltage applied between the standard electrode and the measuring electrode.

3. An oxygen concentration detecting apparatus according to claim 1, further comprising a heater for heating the detecting element, wherein the correcting section changes the heating temperature of the detecting element heated by the heater.

4. An oxygen concentration detecting apparatus according to claim 1, wherein the estimating section estimates the accumulated amount of oxygen based on the temperature of the detecting element.

5. An oxygen concentration detecting apparatus according to claim 1, wherein the estimating section estimates the accumulated amount of oxygen based on the oxygen concentration in a to-be-measured gas.

6. An oxygen concentration detecting apparatus according to claim 4, wherein when the state that the temperature of the detecting element is equal to or more than a predetermined temperature continues for at least a predetermined time, the estimating section estimates that the accumulated amount of oxygen reaches the threshold value.

7. An oxygen concentration detecting apparatus according to claim 5, wherein the detecting element detects the oxygen concentration in an exhaust gas in an internal combustion engine, and the estimating section estimates that the accumulated amount of oxygen reaches the threshold value when the state that the air fuel ratio in the internal combustion engine is leaner than a theoretical air fuel ratio continues for at least a predetermined time.

8. An oxygen concentration detecting apparatus according to claim 2, wherein when it is estimated that accumulated amount of oxygen reaches the threshold value, the correcting section makes the voltage applied between the standard electrode and the measuring electrode lower than an ordinary voltage.

9. An oxygen concentration detecting apparatus according to claim 3, wherein when it is estimated that accumulated amount of oxygen reaches the threshold value, the correcting section makes the voltage of the heater lower than an ordinary voltage.

10. An oxygen concentration detecting apparatus according to claim 1, wherein the detecting element is mounted on an exhaust pipe of an internal combustion engine mounted on a motor cycle.

11. An oxygen concentration detecting apparatus, comprising:
detecting means formed by laminating a standard electrode, an oxygen ion transmissive solid electrolyte, and a measuring electrode;
measuring means for measuring an electromotive force produced in correspondence to a difference between the oxygen partial pressure of the standard electrode and the oxygen partial pressure of the measuring electrode by applying a voltage between the standard electrode and the measuring electrode;
estimating means for estimating the amount of oxygen accumulated to the standard electrode; and
correcting means for changing, when it is estimated that the accumulated amount of oxygen reaches a threshold value, the amount of manipulation of the detecting element in a direction where the amount of oxygen flowing to the standard electrode is suppressed.

12. A method of detecting an oxygen concentration using a detecting element formed by laminating a standard electrode, an oxygen ion transmissive solid electrolyte, and a measuring electrode, comprising the steps of:
applying a voltage between the standard electrode and the measuring electrode;
detecting the oxygen concentration in a to-be-measured gas based on an electromotive force produced in correspondence to a difference between the oxygen partial pressure of the standard electrode and the oxygen partial pressure of the measuring electrode;
estimating the amount of oxygen accumulated to the standard electrode; and
changing, when it is estimated that the accumulated amount of oxygen reaches a threshold value, the amount of manipulation of the detecting element in a direction where the amount of oxygen flowing to the standard electrode is suppressed.

13. A method of detecting an oxygen concentration according to claim 12, wherein the step of changing the amount of manipulation comprises the step of changing the voltage applied between the standard electrode and the measuring electrode.

14. A method of detecting an oxygen concentration according to claim 12, wherein the step of changing the amount of manipulation comprises the step of changing the heating temperature of the detecting element heated by a heater.

15. A method of detecting an oxygen concentration according to claim 12, wherein the step of estimating the accumulated amount of oxygen comprises the steps of:
detecting the temperature of the detecting element; and
estimating the accumulated amount of oxygen based on the temperature of the detecting element.

16. A method of detecting an oxygen concentration according to claim 12, wherein the step of estimating the accumulated amount of oxygen comprises the steps of:
detecting the oxygen concentration in the to-be-measured gas; and
estimating the accumulated amount of oxygen based on the oxygen concentration in the to-be-measured gas.

17. A method of detecting an oxygen concentration according to claim 15, wherein the step of estimating the accumulated amount of oxygen based on the temperature of the detecting element comprises the steps of:
determining whether the temperature of the detecting element is equal to or more than a predetermined temperature;
measuring the duration time during which the state that the temperature of the detecting element is equal to or more than a predetermined temperature continues; and
estimating that the accumulated amount of oxygen reaches a threshold value when the duration time is equal to or more than a predetermined time.

18. A method of detecting an oxygen concentration according to claim 16, wherein the detecting element detects the oxygen concentration in an exhaust gas in an internal combustion engine and the step of estimating the accumulated amount of oxygen based on the oxygen concentration in the to-be-measured gas comprises the steps of:
determining whether the air fuel ratio in the internal combustion engine is leaner than a theoretical air fuel ratio;
measuring the duration time during which the state that the air fuel ratio is leaner than the theoretical air fuel ratio continues; and
estimating that the accumulated amount of oxygen reaches the threshold value when the duration time is equal to or more than a predetermined time.

19. A method of detecting an oxygen concentration according to claim 13, wherein the step of changing the voltage applied between the standard electrode and the measuring electrode comprises the step of making the voltage applied between the standard electrode and the measuring electrode lower than an ordinary voltage when it is estimated that the accumulated amount of oxygen reaches the threshold value.

20. A method of detecting an oxygen concentration according to claim 14, the step of changing the heating temperature of the detecting element heated by a heater comprises the step of making the voltage of the heater lower than an ordinary voltage when it is estimated that the accumulated amount of oxygen reaches a threshold value.
